(19) United States
(12) Patent Application Publication
(10) Pub. No.: US 2025/0200335 A1
(43) Pub. Date: Jun. 19, 2025

(54) SYSTEMS AND METHODS FOR IDENTIFYING MISINFORMATION

(71) Applicant: ADOBE INC., SAN JOSE, CA (US)

(72) Inventors: Jaya Singh, San Jose, CA (US); Seunghyun Yoon, San Jose, CA (US)

(21) Appl. No.: 18/545,072

(22) Filed: Dec. 19, 2023

(51) Int. Cl. G06N 3/0455; G06F 40/279; G06N 3/0895

(52) U.S. Cl. CPC G06N 3/0455; G06F 40/279; G06N 3/0895

(57) ABSTRACT

Methods, non-transitory computer readable media, apparatuses, and systems for identifying misinformation include obtaining a training sample comprising a text graph and a label indicating whether the text graph includes misinformation, and generating a pseudo-sample by modifying the text graph to obtain a modified text graph, where the pseudo-sample includes the modified text graph and the label. A graph classifier is trained to identify misinformation using the training sample and the pseudo-sample.

### BACKGROUND

The following relates generally to data processing, and more specifically to identification of misinformation. Misinformation is incorrect or misleading information, and includes disinformation, which is deliberately deceptive and propagated information. Text including misinformation may be spread online (for example, via social media posts).

Early detection of misinformation is critical so that its propagation may be impeded and harm caused by the misinformation may be prevented. Existing misinformation identification systems include human moderation, which is expensive, time-consuming, and labor-intensive, or training a classifier using supervised learning to label misinformation. However, new forms of misinformation may emerge more rapidly than conventional classifiers are able to be trained to recognize them. There is therefore a need in the art for systems and methods for performing accurate, timely, and cost-effective identification of misinformation.

### SUMMARY

Embodiments of the present disclosure provide a graph classifier trained to identify text misinformation based on a graph representation of the text, where the graph representation is generated by modifying a parent graph representation. According to some aspects, the graph classifier receives a text graph representing misinformation and outputs a label identifying the text graph as representing misinformation.

In some cases, by obtaining the graph representation based on the parent graph representation, aspects of the present disclosure are able to augment a training data set for the graph classifier, such that the augmented training data set includes enough samples of current forms of misrepresentation to allow the graph classifier to be adequately trained to identify the current forms of misrepresentation. In some cases, by training the graph classifier using the graph representation and the parent representation, the graph classifier is able to learn to recognize current forms of misrepresentation. In some cases, the graph classifier is therefore able to more accurately, efficiently, and cost-effectively identify misinformation than conventional misinformation identification systems and techniques.

A method, apparatus, non-transitory computer readable medium, and system for identification of misinformation are described. One or more aspects of the method, apparatus, non-transitory computer readable medium, and system include obtaining a training sample comprising a text graph and a label indicating whether the text graph includes misinformation; generating a pseudo-sample by modifying the text graph to obtain a modified text graph, wherein the pseudo-sample includes the modified text graph and the label; and training a graph classifier to identify misinformation using the training sample and the pseudo-sample.

A method, apparatus, non-transitory computer readable medium, and system for identification of misinformation are described. One or more aspects of the method, apparatus, non-transitory computer readable medium, and system include obtaining a text graph; generating a label for the text graph using a graph classifier, wherein the graph classifier is trained to identify misinformation based on a pseudo-sample obtained by modifying a graph structure of a training sample; and identifying misinformation in the text graph based on the label.

An apparatus and system for identification of misinformation are described. One or more aspects of the apparatus and system include at least one memory component; at least one processor configured to execute instructions stored in the at least one memory component; and a graph classifier comprising parameters stored in the at least one memory component, the graph classifier trained to identify misinformation based on a pseudo-sample obtained by modifying a graph structure of a training sample.

### BRIEF DESCRIPTION OF THE DRAWINGS

FIG. 1 shows an example of a data processing system according to aspects of the present disclosure.

FIG. 2 shows an example of a data processing apparatus according to aspects of the present disclosure.

FIG. 3 shows an example of data flow in a data processing apparatus according to aspects of the present disclosure.

FIG. 4 shows an example of data flow for training a graph classifier according to aspects of the present disclosure.

FIG. 5 shows an example of data flow for further training a graph classifier according to aspects of the present disclosure.

FIG. 6 shows an example of a method for social media moderation according to aspects of the present disclosure.

FIG. 7 shows an example of a method for identifying misinformation according to aspects of the present disclosure.

FIG. 8 shows an example of a method for training a graph classifier according to aspects of the present disclosure.

FIG. 9 shows an example of a text graph according to aspects of the present disclosure.

FIG. 10 shows an example of a modified text graph according to aspects of the present disclosure.

FIG. 11 shows an example of a method for training a graph classifier based on a predicted pseudo-sample according to aspects of the present disclosure.

### DETAILED DESCRIPTION

Misinformation is incorrect or misleading information, and includes disinformation, which is deliberately deceptive and propagated information. Text including misinformation may be spread online (for example, via social media posts). Early detection of misinformation is critical for minimizing the extent of potential harm by impeding its propagation.

Existing misinformation identification systems include human moderation, which is expensive, time-consuming, and labor-intensive, or training a classifier using supervised learning to label misinformation. However, new forms of misinformation may emerge more rapidly than conventional classifiers are able to be trained to recognize them, and conventional classifiers fail to offer a viable solution for early detection due to a lack of labeled data at the onset of content dissemination.

Aspects of the present disclosure address this challenge of early detection of misinformation for proactive content moderation under data constraints by implementing a weakly supervised classification approach, in which a pseudo-sample is generated based on a text graph representation of misinformation, and a graph classifier is trained based on the pseudo-sample and the text graph representation. In some cases, the graph classifier is pre-trained using the pseudo-sample, and then the graph classifier is self-trained using an unlabeled sample of a text graph.

Embodiments of the present disclosure provide a graph classifier trained to identify text misinformation based on a graph representation of the text, where the graph representation is generated by modifying a parent graph representation. According to some aspects, the graph classifier receives a text graph representing misinformation and outputs a label identifying the text graph as representing misinformation.

In some cases, by obtaining the graph representation based on the parent graph representation, aspects of the present disclosure are able to augment a training data set for the graph classifier, such that the augmented training data set includes enough samples of current forms of misrepresentation to allow the graph classifier to be adequately trained to identify the current forms of misrepresentation. In some cases, by training the graph classifier using the graph representation and the parent representation, the graph classifier is able to learn to recognize current forms of misrepresentation. In some cases, the graph classifier is therefore able to more accurately, efficiently, and cost-effectively identify misinformation than conventional misinformation identification systems and techniques.

An aspect of the present disclosure is used in a social media context. The rapid growth of user-generated content on online platforms and the heavy dependence of users on these online discourses for information consumption have led to an urgent need for effective content moderation. Unacceptable content which is deceptive or inappropriate, including rumors, misinformation, abusive/hate speech, and offensive material, can cause significant harm by undermining trust in digital communities and maliciously influencing public opinions.

The prevention of the propagation of such harmful material in early stages of dissemination is critical to minimize potential harm caused by the content. These early stages of propagation are typically characterized by a lack of labeled data, while the content itself is usually marked by both text of the source content and the subsequent follow-up response thread consisting of interactions and replies by other users. The source content and the response thread can be represented as a text graph.

According to an aspect of the present disclosure, a user provides the system with a text graph representation of a social media post. The system uses a graph classifier, trained to identify misinformation using an augmented training set including a sample labeled text graph and a pseudo-sample generated based on the labeled text graph, to determine that the social media post includes misinformation. In response to the identification, the system performs a moderation action for the social media post (such as providing a warning to an account associated with the social media post, adding a content warning to the social media post, removing the social media post from public view, etc.).

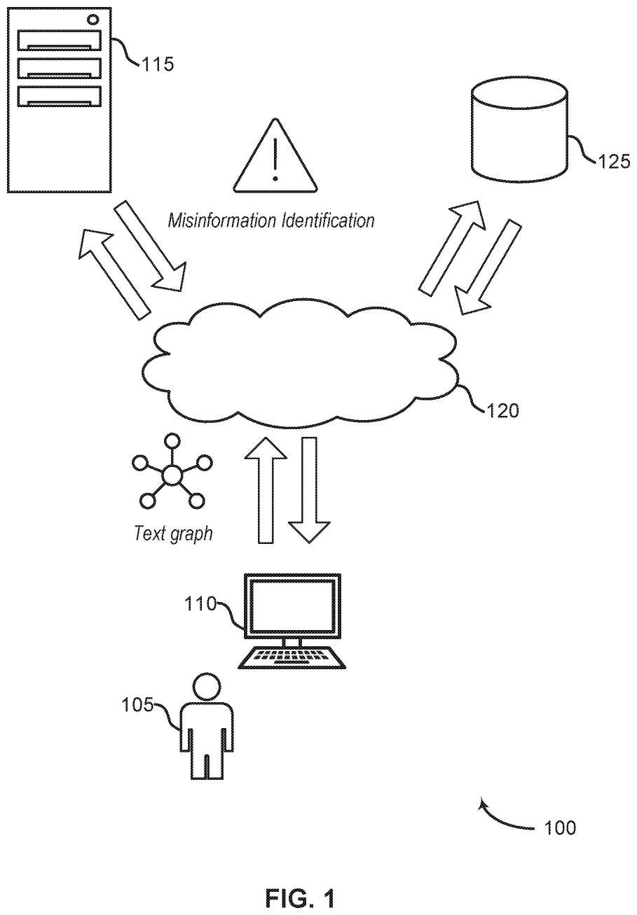

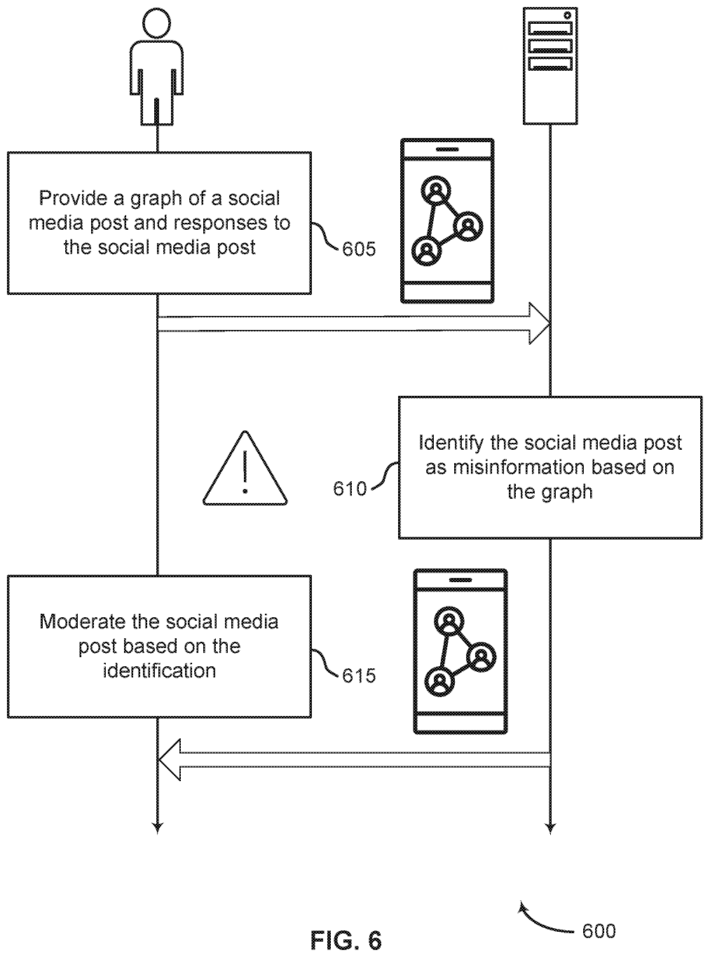

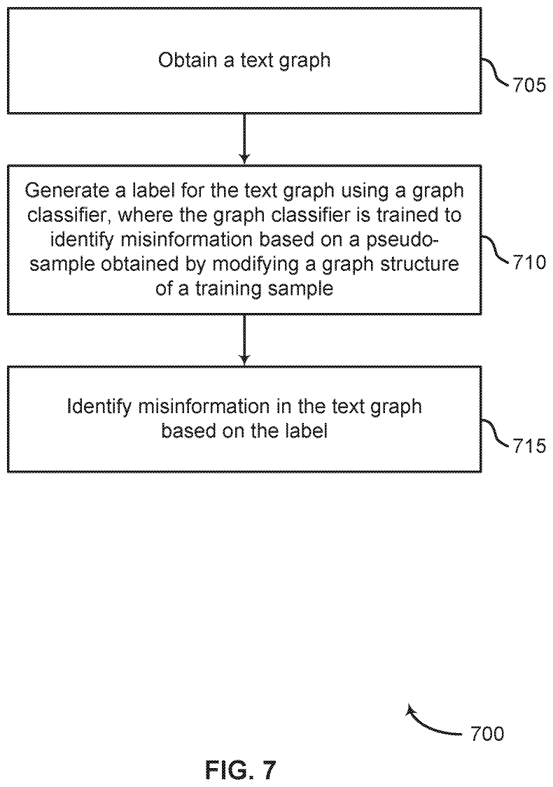

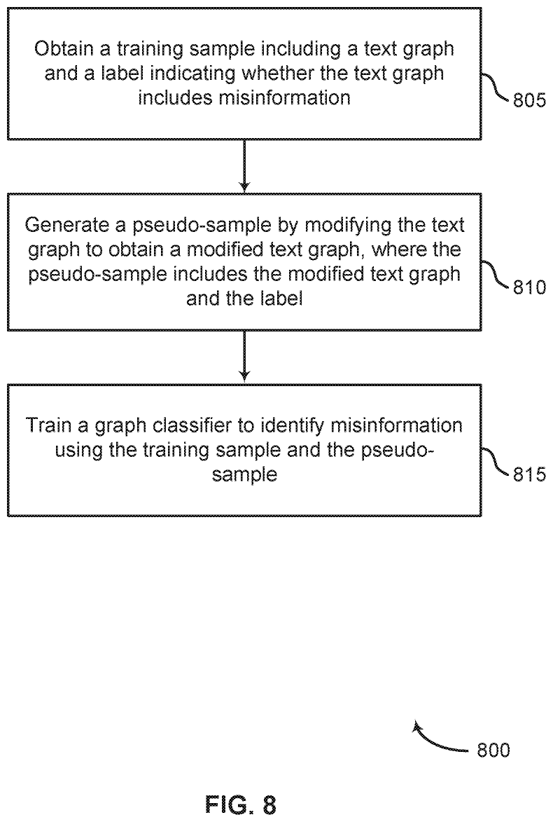

Further example applications of the present disclosure in the social media moderation context are provided with reference to FIG. 6. Details regarding the architecture of a data processing system are provided with reference to FIGS. 1-5. Examples of a process for misinformation identification are provided with reference to FIGS. 6-7. Examples of a process for training a machine learning model are provided with reference to FIGS. 8-11.

### Data Processing System

A system and an apparatus for identification of misinformation is described with reference to FIGS. 1-5. One or more aspects of the system and the apparatus include at least one memory component; at least one processor configured to execute instructions stored in the at least one memory component; and a graph classifier comprising parameters stored in the at least one memory component, the graph classifier trained to identify misinformation based on a pseudo-sample obtained by modifying a graph structure of a training sample.

Some examples of the system and the apparatus further include a training component configured to train the graph classifier. Some examples of the system and the apparatus further include a pseudo-sample generator configured to generate the pseudo-sample. In some aspects, the pseudo-sample generator comprises a language generation model.

Some examples of the system and the apparatus further include a text encoder configured to compute a node embedding for the training sample. Some examples of the system and the apparatus further include a social media application configured to perform a moderation action based on identifying misinformation.

FIG. 1 shows an example of data processing system 100 according to aspects of the present disclosure. The example shown includes user 105, user device 110, data processing apparatus 115, cloud 120, and database 125.

In the example of FIG. 1, data processing apparatus 115 receives a text graph from user 105 via user device 110. In some cases, user 105 provides the text graph via a user interface (such as a graphical user interface) displayed on user device 110 by data processing apparatus 115. Data processing apparatus 115 receives the text graph and identifies that the root node of the text graph includes misinformation. Data processing apparatus 115 provides the identification to user 105 via user device 110.

According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by data processing apparatus 115. In some aspects, the user interface allows information to be communicated between user 105 and data processing apparatus 115.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

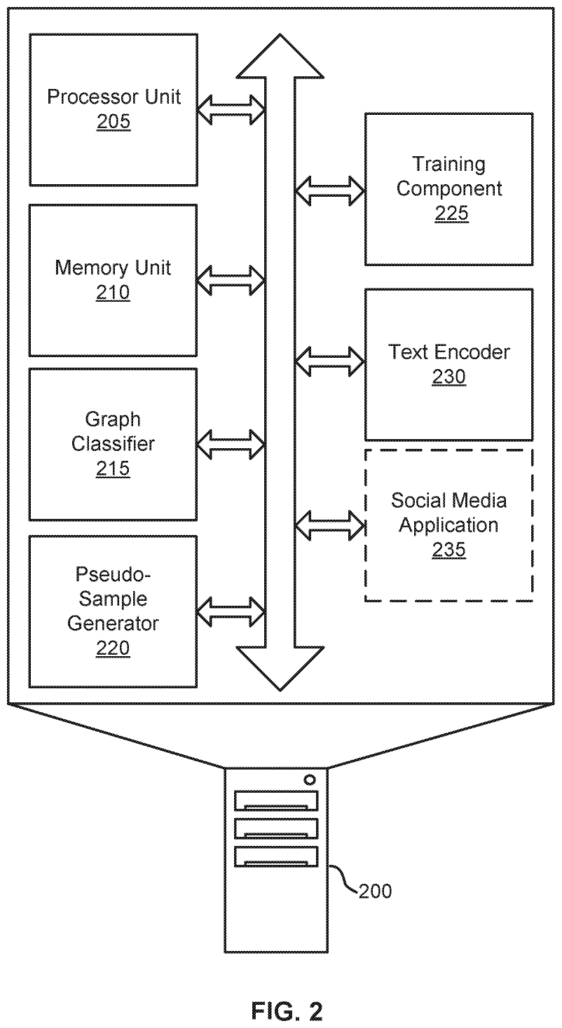

Data processing apparatus 115 is an example of, or includes aspects of, the corresponding element described with reference to FIGS. 2-5. According to some aspects, data processing apparatus 115 includes a computer-implemented network. In some embodiments, the computer-implemented network includes a machine learning model. In some embodiments, data processing apparatus 115 also includes one or more processors, a memory subsystem, a communication interface, an I/O interface, one or more user interface components, and a bus. Additionally, in some embodiments, data processing apparatus 115 communicates with user device 110 and database 125 via cloud 120.

In some cases, data processing apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Further detail regarding the architecture of data processing apparatus 115 is provided with reference to FIGS. 2-5. Further detail regarding a process for identifying misinformation is provided with reference to FIGS. 6-7. Examples of a process for training a machine learning model are provided with reference to 8-11.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet.

Some large cloud networks have functions distributed over multiple locations from central servers. A server is designated an edge server if it has a direct or close connection to a user. In some cases, cloud 120 is limited to a single organization. In other examples, cloud 120 is available to many organizations.

In one example, cloud 120 includes a multi-layer communications network comprising multiple edge routers and core routers. In another example, cloud 120 is based on a local collection of switches in a single physical location. According to some aspects, cloud 120 provides communications between user device 110, data processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to data processing apparatus 115 and communicates with data processing apparatus 115 via cloud 120. According to some aspects, database 125 is included in data processing apparatus 115.

FIG. 2 shows an example of data processing apparatus 200 according to aspects of the present disclosure. Data processing apparatus 200 is an example of, or includes aspects of, the corresponding element described with reference to FIGS. 1 and 3-5. In one aspect, data processing apparatus 200 includes processor unit 205, memory unit 210, graph classifier 215, pseudo-sample generator 220, training component 225, text encoder 230, and social media application 235.

Processor unit 205 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 205 is configured to operate a memory array using a memory controller. In other cases, a memory controller is integrated into processor unit 205. In some cases, processor unit 205 is configured to execute computer-readable instructions stored in memory unit 210 to perform various functions. In some aspects, processor unit 205 includes special purpose components for modem processing, baseband processing, digital signal processing, or transmission processing.

Memory unit 210 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 205 to perform various functions described herein.

In some cases, memory unit 210 includes a basic input/output system (BIOS) that controls basic hardware or software operations, such as an interaction with peripheral components or devices. In some cases, memory unit 210 includes a memory controller that operates memory cells of memory unit 210. For example, the memory controller may include a row decoder, column decoder, or both. In some cases, memory cells within memory unit 210 store information in the form of a logical state.

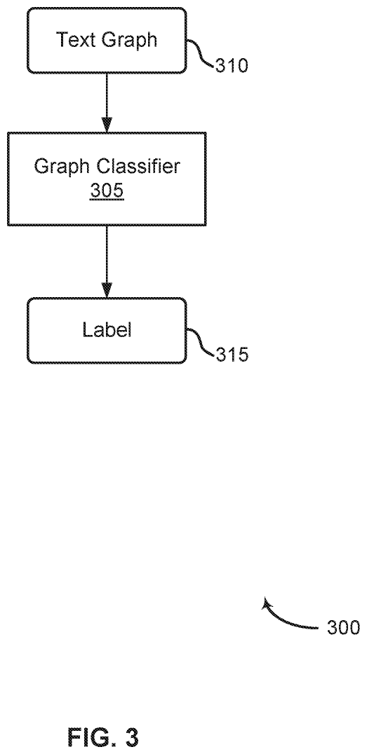

Graph classifier 215 is an example of, or includes aspects of, the corresponding element described with reference to FIGS. 3-5. According to some aspects, graph classifier 215 is implemented as software stored in memory unit 210 and executable by processor unit 205, as firmware, as one or more hardware circuits, or as a combination thereof.

According to some aspects, graph classifier 215 comprises graph classification parameters (e.g., machine learning parameters) stored in memory unit 210. Machine learning parameters, also known as model parameters or weights, are variables that provide a behavior and characteristics of a machine learning model. Machine learning parameters can be learned or estimated from training data and are used to make predictions or perform tasks based on learned patterns and relationships in the data.

Machine learning parameters are typically adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

Artificial neural networks (ANNs) have numerous parameters, including weights and biases associated with each neuron in the network, that control a degree of connections between neurons and influence the neural network's ability to capture complex patterns in data.

An ANN is a hardware component or a software component that includes a number of connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

In some cases, the signals between nodes comprise real numbers, and the output of each node is computed by a function of the sum of its inputs. In some examples, nodes may determine their output using other mathematical algorithms, such as selecting the max from the inputs as the output, or any other suitable algorithm for activating the node. Each node and edge are associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

During a training process of an ANN, the node weights are adjusted to improve the accuracy of the result (i.e., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

According to some aspects, graph classifier 215 comprises one or more ANNs trained to identify misinformation based on a pseudo-sample obtained by modifying a graph structure of a training sample. For example, in some cases, graph classifier 215 comprises a graph neural network (GNN) trained to perform classification on graph-structured text.

A GNN is a type of neural network architecture designed to operate on graph-structured data. Unlike traditional neural networks that process grid-structured data like images or sequences, GNNs are specifically tailored for tasks involving complex relationships and dependencies among entities represented as nodes in a graph. The graph typically consists of nodes connected by edges, where each node represents an entity, and edges encode the relationships between entities. GNNs leverage message-passing mechanisms to iteratively update node representations by aggregating information from neighboring nodes. This allows the network to capture and propagate information through the graph, enabling it to discern intricate patterns and dependencies. GNNs have found applications in various domains such as social network analysis, recommendation systems, and biological network analysis, where the inherent structure of the data is best represented as a graph. The flexibility and adaptability of GNNs make them a powerful tool for tasks requiring a nuanced understanding of interconnected data.

Classification is a process of assigning input data points to specific categories or classes. In some cases, for example, graph classifier 215 is trained to label an input text graph as being misinformation by predicting a class probability that a root node of the input text graph belongs to a misinformation class.

According to some aspects, graph classifier 215 obtains a text graph. In some examples, graph classifier 215 generates a label for the text graph. In some examples, graph classifier 215 identifies misinformation in the text graph based on the label. In some aspects, the text graph includes a set of text nodes and at least one edge connecting at least two of the set of text nodes. In some aspects, the text graph includes a social media post. In some aspects, the text graph includes a response to the social media post.

According to some aspects, graph classifier 215 obtains an unlabeled sample including an additional text graph. In some examples, graph classifier 215 generates a pseudo-label for the unlabeled sample using the graph classifier 215 to obtain a predicted pseudo-sample including the unlabeled sample and the pseudo-label.

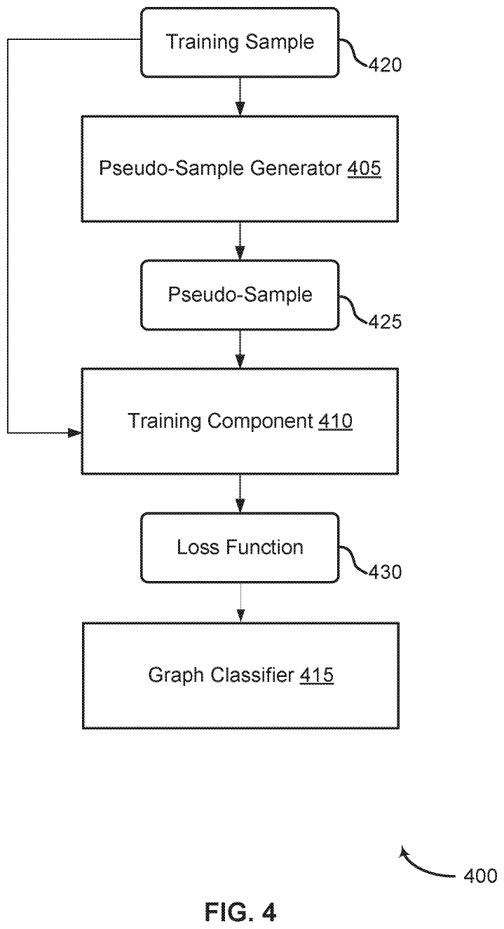

Pseudo-sample generator 220 is an example of, or includes aspects of, the corresponding element described with reference to FIG. 4. According to some aspects, pseudo-sample generator 220 is implemented as software stored in memory unit 210 and executable by processor unit 205, as firmware, as one or more hardware circuits, or as a combination thereof. According to some aspects, pseudo-sample generator 220 is configured to generate a pseudo-sample.

According to some aspects, pseudo-sample generator 220 obtains a training sample including a text graph and a label indicating whether the text graph includes misinformation. In some examples, pseudo-sample generator 220 generates a pseudo-sample by modifying the text graph to obtain a modified text graph, where the pseudo-sample includes the modified text graph and the label. In some aspects, the text graph includes a root node and the label indicates whether the root node includes misinformation.

In some aspects, the text graph includes a set of text nodes and at least one edge connecting at least two of the set of text nodes. In some examples, modifying the text graph includes adding an additional text node or an additional edge. In some examples, modifying the text graph includes removing at least one of the set of text nodes or the at least one edge. In some examples, modifying the text graph includes modifying at least one of the set of text nodes.

According to some aspects, pseudo-sample generator 220 includes or implements a synthetic graph generation algorithm. According to some aspects, pseudo-sample generator 220 comprises pseudo-sample parameters (e.g., machine learning parameters) stored in memory unit 210. In some aspects, pseudo-sample generator 220 includes a GNN. In some aspects, pseudo-sample generator 220 includes a language generation model. In some cases, pseudo-sample generator 220 includes a generative mixture model that utilizes a spherical distribution of an input class of text. In some cases, the language generation model is a large language model (LLM).

An LLM refers to one or more ANNs trained on large amounts of textual data to understand and generate human-like language. LLMs are often based on transformer architectures. In some cases, a transformer comprises one or more ANNs comprising attention mechanisms that enable the transformer to weigh an importance of different words or tokens within a sequence. In some cases, a transformer processes entire sequences simultaneously in parallel, making the transformer highly efficient and allowing the transformer to capture long-range dependencies more effectively.

An attention mechanism is a key component in some ANN architectures, particularly ANNs employed in natural language processing (NLP) and sequence-to-sequence tasks, that allows an ANN to focus on different parts of an input sequence when making predictions or generating output.

NLP refers to techniques for using computers to interpret or generate natural language. In some cases, NLP tasks involve assigning annotation data such as grammatical information to words or phrases within a natural language expression. Different classes of machine-learning algorithms have been applied to NLP tasks. Some algorithms, such as decision trees, utilize hard if-then rules. Other systems use neural networks or statistical models which make soft, probabilistic decisions based on attaching real-valued weights to input features. In some cases, these models express the relative probability of multiple answers.

Some sequence models (such as recurrent neural networks) process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering a relevance of each input element with respect to a current state of the ANN.

In some cases, an ANN employing an attention mechanism receives an input sequence and maintains its current state, which represents an understanding or context. For each element in the input sequence, the attention mechanism computes an attention score that indicates the importance or relevance of that element given the current state. The attention scores are transformed into attention weights through a normalization process, such as applying a softmax function. The attention weights represent the contribution of each input element to the overall attention. The attention weights are used to compute a weighted sum of the input elements, resulting in a context vector. The context vector represents the attended information or the part of the input sequence that the ANN considers most relevant for the current step. The context vector is combined with the current state of the ANN, providing additional information and influencing subsequent predictions or decisions of the ANN.

In some cases, by incorporating an attention mechanism, an ANN dynamically allocates attention to different parts of the input sequence, allowing the ANN to focus on relevant information and capture dependencies across longer distances.

In some cases, calculating attention involves three basic steps. First, a similarity between a query vector Q and a key vector K obtained from the input is computed to generate attention weights. In some cases, similarity functions used for this process include dot product, splice, detector, and the like. Next, a softmax function is used to normalize the attention weights. Finally, the attention weights are weighed together with their corresponding values V. In the context of an attention network, the key K and value V are typically vectors or matrices that are used to represent the input data. The key K is used to determine which parts of the input the attention mechanism should focus on, while the value V is used to represent the actual data being processed.

In some cases, a transformer comprises an encoder-decoder structure. In some cases, the encoder of the transformer processes an input sequence and encodes the input sequence into a set of high-dimensional representations. In some cases, the decoder of the transformer generates an output sequence based on the encoded representations and previously generated tokens. In some cases, the encoder and the decoder are composed of multiple layers of self-attention mechanisms and feed-forward ANNs.

In some cases, the self-attention mechanism allows the transformer to focus on different parts of an input sequence while computing representations for the input sequence. In some cases, the self-attention mechanism captures relationships between words of a sequence by assigning attention weights to each word based on a relevance to other words in the sequence, thereby enabling the transformer to model dependencies regardless of a distance between words.

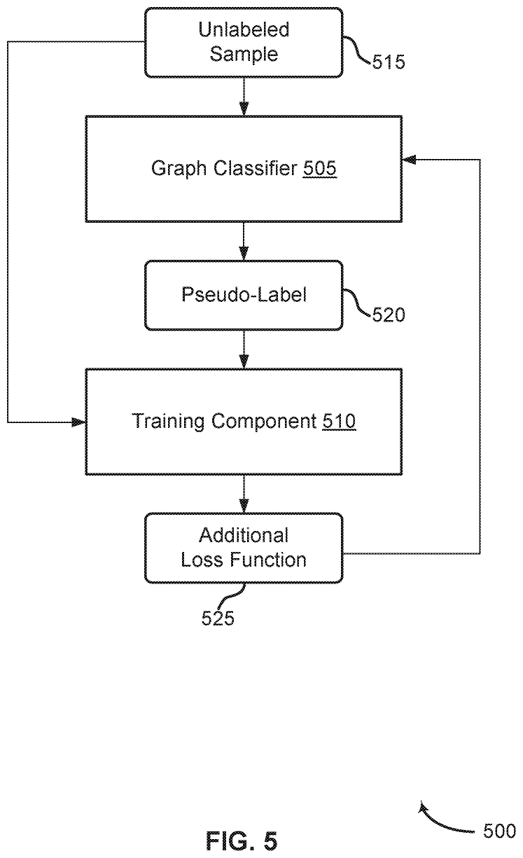

Training component 225 is an example of, or includes aspects of, the corresponding element described with reference to FIGS. 4-5. According to some aspects, training component 225 is implemented as software stored in memory unit 210 and executable by processor unit 205, as firmware, as one or more hardware circuits, or as a combination thereof. According to some aspects, training component 225 is configured to train graph classifier 215.

According to some aspects, training component 225 trains graph classifier 215 to identify misinformation using the training sample and the pseudo-sample. In some examples, training graph classifier 215 includes generating a predicted label for the text graph and computing a loss function based on the label and the predicted label. In some examples, training component 225 performs additional training of graph classifier 215 based on a predicted pseudo-sample.

According to some aspects, text encoder 230 is implemented as software stored in memory unit 210 and executable by processor unit 205, as firmware, as one or more hardware circuits, or as a combination thereof. According to some aspects, text encoder 230 comprises text encoding parameters (e.g., machine learning parameters) stored in memory unit 210. In some cases, text encoder 230 comprises a recurrent neural network (RNN), a transformer, or other ANN suitable for encoding textual information.

A recurrent neural network (RNN) is a class of ANN in which connections between nodes form a directed graph along an ordered (i.e., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

According to some aspects, text encoder 230 is configured to compute a node embedding for the training sample. According to some aspects, text encoder 230 computes a node embedding for each of the set of text nodes, where graph classifier 215 takes the node embedding as input.

According to some aspects, social media application 235 is implemented as software stored in memory unit 210 and executable by processor unit 205. According to some aspects, social media application 235 is configured to perform a moderation action based on identifying misinformation. According to some aspects, social media application 235 is omitted from data processing apparatus 200. According to some aspects, social media application 235 is software configured to interact with one or more social media services. According to some aspects, social media application 235 performs a moderation action based on identifying misinformation in the text graph.

FIG. 3 shows an example of data flow in a data processing apparatus 300 according to aspects of the present disclosure. The example shown includes data processing apparatus 300, text graph 310, and label 315.

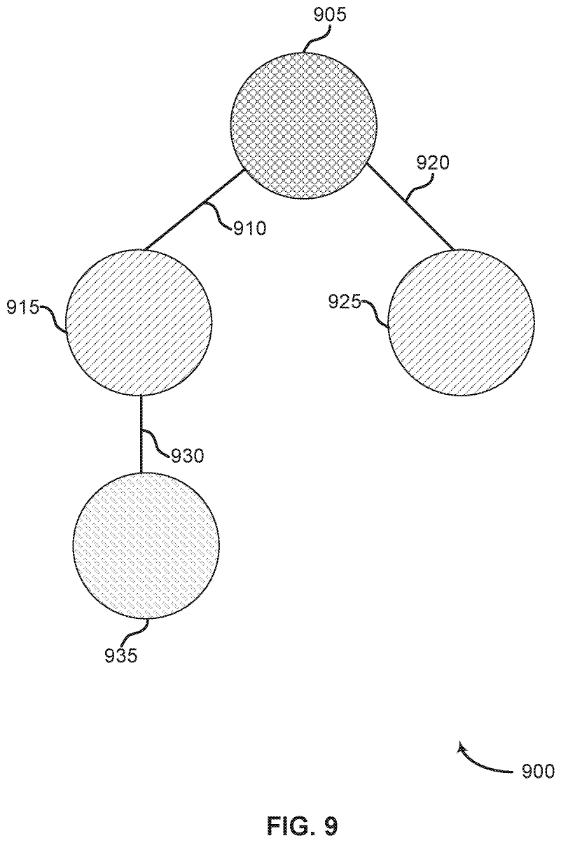

Data processing apparatus 300 is an example of, or includes aspects of, the corresponding element described with reference to FIGS. 1-2 and 4-5. Text graph 310 is an example of, or includes aspects of, the corresponding element described with reference to FIG. 9.

In one aspect, data processing apparatus 300 includes graph classifier 305. Graph classifier 305 is an example of, or includes aspects of, the corresponding element described with reference to FIGS. 2-3 and 5.

In the example of FIG. 3, graph classifier 305 receives text graph 310 as input and generates label 315 for text graph 310 as output as described with reference to FIG. 6. In some cases, label 315 identifies text graph 310 as including misinformation.

FIG. 4 shows an example of data flow for training a graph classifier 415 according to aspects of the present disclosure. The example shown includes data processing apparatus 400, training sample 420, pseudo-sample 425, and loss function 430.

Data processing apparatus 400 is an example of, or includes aspects of, the corresponding element described with reference to FIGS. 1-3 and 5. In one aspect, data processing apparatus 400 includes pseudo-sample generator 405, training component 410, and graph classifier 415. Pseudo-sample generator 405 is an example of, or includes aspects of, the corresponding element described with reference to FIG. 2. Training component 410 is an example of, or includes aspects of, the corresponding element described with reference to FIGS. 2 and 5. Graph classifier 415 is an example of, or includes aspects of, the corresponding element described with reference to FIGS. 2, 3, and 5.

In the example of FIG. 4, pseudo-sample generator 405 receives training sample 420 as input and outputs pseudo-sample 425 as described with reference to FIGS. 8-10. Training component 410 determines loss function 430 based on training sample 420 and pseudo-sample 425 as described with reference to FIG. 8. Training component 410 trains graph classifier 415 using loss function 430 as described with reference to FIG. 8.

FIG. 5 shows an example of data flow for further training a graph classifier 505 according to aspects of the present disclosure. The example shown includes data processing apparatus 500, unlabeled sample 515, pseudo-label 520, and additional loss function 525. Data processing apparatus 500 is an example of, or includes aspects of, the corresponding element described with reference to FIGS. 1-4.

In one aspect, data processing apparatus 500 includes graph classifier 505 and training component 510. Graph classifier 505 is an example of, or includes aspects of, the corresponding element described with reference to FIGS. 2-4. Training component 510 is an example of, or includes aspects of, the corresponding element described with reference to FIGS. 2 and 4.

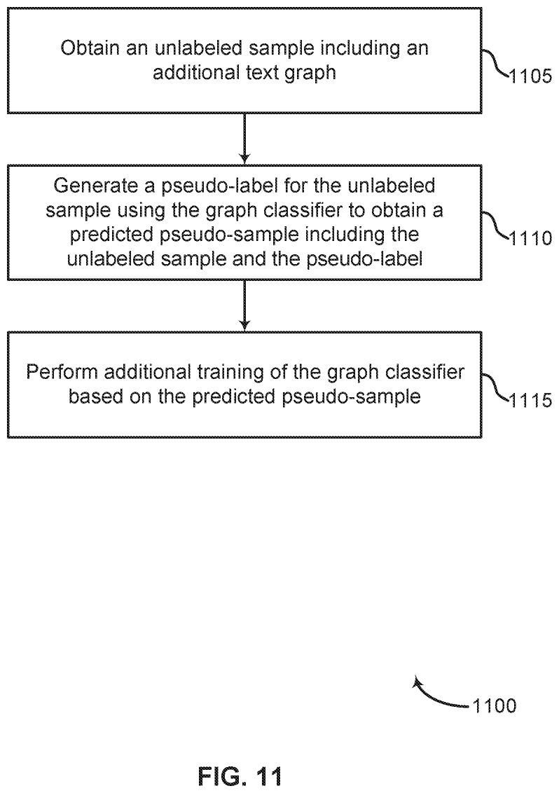

In the example of FIG. 5, graph classifier 505 receives unlabeled sample 515 as input and generates pseudo-label 520 for unlabeled sample 515 as output as described with reference to FIG. 11. Training component 510 determines additional loss function 525 based on unlabeled sample 515 and pseudo-label 520 as described with reference to FIG. 11. Training component 510 trains graph classifier 505 using additional loss function 525 as described with reference to FIG. 11.

### Misinformation Identification

A method for identification of misinformation is described with reference to FIGS. 6-7. One or more aspects of the method include obtaining a text graph; generating a label for the text graph using a graph classifier, wherein the graph classifier is trained to identify misinformation based on a pseudo-sample obtained by modifying a graph structure of a training sample; and identifying misinformation in the text graph based on the label.

In some aspects, the text graph includes a plurality of text nodes and at least one edge connecting at least two of the plurality of text nodes. In some aspects, the text graph comprises a social media post. Some examples of the method further include performing a moderation action based on identifying misinformation in the text graph. In some aspects, the text graph includes a response to the social media post.

FIG. 6 shows an example of a method 600 for social media moderation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 6, an embodiment of the present disclosure is used in a social media moderation context. For example, the system receives a text graph of a social media post and a response to the social media post. The system identifies that the social media post includes misinformation based on the text graph. The system moderates the social media post based on the identification.

Social media refers to services such as online platforms, websites, and applications that facilitate the creation, sharing, and exchange of information, ideas, and content among users. These platforms often allow users to connect with others, build virtual communities, and engage in various forms of communication, such as text, images, and videos. Social media has become a prominent and influential aspect of modern communication, enabling people to interact, collaborate, and share information on a global scale. As used herein, a “social media post” refers to text data provided by a user of a social media service to the social media service for purpose of display by the social media service. In some cases, the social media post is represented by the root node of the text graph. In some cases, one or more additional social media posts that are responsive to the social media post, to each other, or to a combination thereof are represented by one or more respective child nodes of the text graph.

At operation 605, a user provides a graph of a social media post and responses to the social media post. In some cases, the operations of this step refer to, or may be performed by, a user as described with reference to FIG. 1. For example, in some cases, the user provides the graph to a data processing apparatus of the data processing system (such as the data processing apparatus described with reference to FIGS. 1-5) via a user interface provided on a user device (such as the user device described with reference to FIG. 1) by the data processing apparatus.

At operation 610, the system identifies the social media post as misinformation based on the graph. In some cases, the operations of this step refer to, or may be performed by, a data processing system as described with reference to FIG. 1. For example, in some cases, the data processing apparatus identifies the social media post as misinformation using a graph classifier (such as the graph classifier described with reference to FIGS. 2-5) as described with reference to FIG. 7.

At operation 615, the system moderates the social media post based on the identification. In some cases, the operations of this step refer to, or may be performed by, a data processing system as described with reference to FIG. 1. For example, in some cases, a social media application of the data processing apparatus (such as the social media application described with reference to FIG. 2) moderates the social media post as described with reference to FIG. 7.

FIG. 7 shows an example of a method 700 for identifying misinformation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 7, the system identifies misinformation using a graph classifier trained to identify misinformation based on a pseudo-sample obtained by modifying a graph structure of a training sample. As used herein, “misinformation” refers to incorrect or misleading information.

According to some aspects, because the graph classifier is trained based on a pseudo-sample obtained by modifying a graph structure of a training sample, the graph classifier is able to keep pace with emergent forms of misinformation, and is therefore able to more accurately identify misinformation than conventional misinformation identification systems.

At operation 705, the system obtains a text graph. In some cases, the operations of this step refer to, or may be performed by, a graph classifier as described with reference to FIGS. 2-5.

In some cases, the graph classifier receives the text graph from a user (such as the user described with reference to FIGS. 1-2). In some cases, the graph classifier retrieves the text graph from a database (such as the database described with reference to FIG. 1). In some cases, the text graph comprises a root node, at least one child node, and at least one edge, where the root node represents text data, each child node represents a response to the text of the root node or of another child node, and an edge of the graph indicates a relationship between respective nodes of the graph. In some cases, the text graph includes a social media post. A text graph is described in further detail with reference to FIG. 9.

At operation 710, the system generates a label for the text graph using a graph classifier, where the graph classifier is trained to identify misinformation based on a pseudo-sample obtained by modifying a graph structure of a training sample. In some cases, the operations of this step refer to, or may be performed by, a graph classifier as described with reference to FIGS. 2-5. In some cases, the graph classifier is trained as described with reference to FIGS. 8-11.

For example, in some cases, the graph classifier determines that the text graph includes misinformation, and generates a label for the text graph indicating that the text graph includes misinformation. In some cases, the graph classifier associates the label with the text graph. In some cases, the graph classifier stores data indicative of the association in a database (such as the database described with reference to FIG. 1).

At operation 715, the system identifies misinformation in the text graph based on the label. In some cases, the operations of this step refer to, or may be performed by, a graph classifier as described with reference to FIGS. 2-5.

For example, in some cases, the graph classifier identifies the root node of the text graph as including misinformation when the graph classifier determines that the text graph is associated with a label that identifies the text graph as including misinformation.

In some cases, a social media application performs a moderation action based on the identification of misinformation in the text graph. In an example, the text graph comprises a social media post, and the graph classifier provides the identification of misinformation included in the text graph to the social media application. The social media application can perform a moderation action based on the identification, such as sending a warning to the social media service, account, or combination thereof associated with the social media post, adding a message corresponding to the identification to the social media post, removing the social media post from the social media service, limiting access to the social media service by the account, or any other moderation action as appropriate.

### Training

A method for identification of misinformation is described with reference to FIGS. 8-11. One or more aspects of the method include obtaining a training sample comprising a text graph and a label indicating whether the text graph includes misinformation; generating a pseudo-sample by modifying the text graph to obtain a modified text graph, wherein the pseudo-sample includes the modified text graph and the label; and training a graph classifier to identify misinformation using the training sample and the pseudo-sample. In some aspects, the text graph includes a root node and the label indicates whether the root node includes misinformation.

Some examples of the method further include obtaining an unlabeled sample including an additional text graph. Some examples further include generating a pseudo-label for the unlabeled sample using the graph classifier to obtain a predicted pseudo-sample including the unlabeled sample and the pseudo-label. Some examples further include performing additional training of the graph classifier based on the predicted pseudo-sample.

In some aspects, the text graph includes a plurality of text nodes and at least one edge connecting at least two of the plurality of text nodes. In some examples, modifying the text graph comprises adding an additional text node or an additional edge. In some examples, modifying the text graph comprises removing at least one of the plurality of text nodes or the at least one edge. In some examples, modifying the text graph comprises modifying at least one of the plurality of text nodes.

In some examples, training the graph classifier comprises generating a predicted label for the text graph. Some examples further include computing a loss function based on the label and the predicted label. Some examples of the method further include computing a node embedding for each of the plurality of text nodes, wherein the graph classifier takes the node embedding as input.

Referring to FIG. 8, the system trains a graph classifier to identify misinformation using a training sample and a pseudo-sample generated based on the training sample. By generating the pseudo-sample based on the training sample, the system increases an amount of data for training the graph classifier, which allows the graph classifier to be trained to recognize emergent forms of misinformation for which a significant number of training samples do not yet exist. Therefore, the trained graph classifier is able to keep pace with emergent forms of misinformation and make more accurate identifications of misinformation than conventional misinformation identification systems. Furthermore, by generating the pseudo-sample by modifying a graph structure of the training sample, the system is able to train the graph classifier to understand a relationship between graph structures representative of conversational threading and forms of misinformation.

FIG. 8 shows an example of a method 800 for training a graph classifier according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system obtains a training sample including a text graph and a label indicating whether the text graph includes misinformation. In some cases, the operations of this step refer to, or may be performed by, a pseudo-sample generator as described with reference to FIG. 2.

According to some aspects, the text graph includes a root node. In some cases, the root node represents text data. In some cases, the label indicates that the root node includes misinformation. In some cases, a text graph includes a set of text nodes and at least one edge connecting at least two of the set of text nodes. For example, in some cases, the text graph includes at least one child node and at least one edge, where the root node comprises text, each child node represents a text response to the text of the root node or of another child node, and an edge of the graph indicates a relationship between respective nodes of the graph. A text graph is described in further detail with reference to FIG. 9.

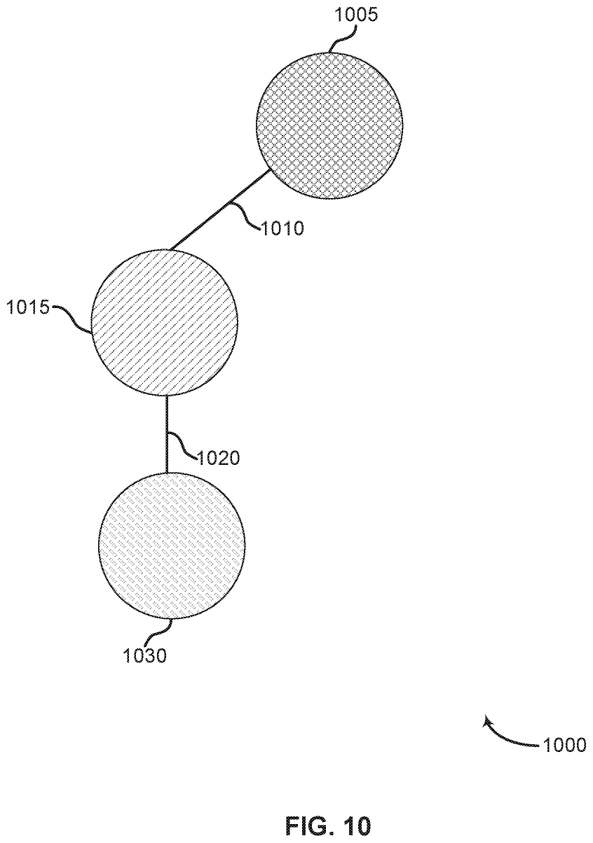

At operation 810, the system generates a pseudo-sample by modifying the text graph to obtain a modified text graph, where the pseudo-sample includes the modified text graph and the label. In some cases, the operations of this step refer to, or may be performed by, a pseudo-sample generator as described with reference to FIG. 2. An example of a modified text graph is described with reference to FIG. 10.

According to some aspects, given an initial set of N seed training samples {Tᵢ: 1≤i≤N}, the pseudo-sample generator generates a set of K pseudo-samples {Tᵢⱼ′: 1≤i≤N, 1≤j≤K} per each initial seed training sample, where a label of a pseudo-sample Tᵢⱼ′ is the same as a label of an associated parent seed training sample Tᵢ.

According to some aspects, the structure of the text graph can be modified while maintaining similar statistical structural properties. In some cases, modifying the text graph includes adding an additional text node or an additional edge. In some cases, modifying the text graph includes removing at least one of the set of text nodes or the at least one edge. In some cases, the pseudo-sample generator includes a graph modifying algorithm, and in some cases, the pseudo-sample generator modifies the text graph according to the graph modifying algorithm to generate the pseudo-sample. In some cases, the pseudo-sample generator includes a GNN, and modifying the text graph includes outputting the modified based on an input of the text graph.

According to some aspects, modifying the text graph includes modifying at least one of the set of text nodes. For example, in some cases, the pseudo-sample generator adds one or more words to text represented by the text node, replaces one or more words in the text, or a combination thereof using an algorithm or a machine learning model, such as an LLM or a generative mixture model. In some cases, the pseudo-sample preserves the semantic meaning of the training sample. In some cases, the generative mixture model utilizes a spherical distribution of an input class of text, where the mixture model iteratively generates a series of terms to construct the pseudo-sample. In some cases, during the term generation process, the generative mixture model decides between a background distribution with a probability a, where 0<α<1, and the class-specific probability distribution with a probability of 1−α.

According to some aspects, the pseudo-sample generator retrieves (for example, from the database) an unlabeled training sample having a similar graph structure as the training sample, and identifies the unlabeled training sample as the pseudo-sample.

According to some aspects, a text encoder (such as the text encoder described with reference to FIG. 2) computes a node embedding for each of the plurality of text nodes. In some cases, the pseudo-sample generator constructs a graph with attributed nodes while treating each node as per their text embedding. In some cases, the pseudo-sample generator uses a synthetic graph generation algorithm to augment data with different structures and accordingly adjusted node embeddings.

According to some aspects, by generating the pseudo-sample based on the training sample, the system is able to increase or augment a training data set of text graphs including an emergent misinformation style to a significant size, and is therefore able to use weak supervision methods based on the training data set to train a graph classifier that is able to accurately identify the emergent misinformation style.

At operation 815, the system trains a graph classifier to identify misinformation using the training sample and the pseudo-sample. In some cases, the operations of this step refer to, or may be performed by, a training component as described with reference to FIGS. 2, 4, and 5. According to some aspects, the training component trains the graph classifier using the initial set of N seed samples and their corresponding K pseudo-samples.

For example, in some cases, the training component employs contrastive learning to train the graph classifier using a training dataset including the training sample and the pseudo-sample. Contrastive learning is a machine learning approach that involves training a model to distinguish between positive pairs (similar instances) and negative pairs (dissimilar instances). The objective is to encourage the model to learn representations where similar instances are closer together in the feature space while dissimilar instances are farther apart. Contrastive learning helps the model to develop meaningful and generalized representations by emphasizing the differences between examples and promoting a robust understanding of the underlying data structure.

In some cases, the graph classifier generates a predicted label for the text graph. In some cases, the graph classifier takes the node embedding as input. In some cases, the training component computes a loss function based on the label and the predicted label. For example, in some cases, the training component computes the loss function by comparing the label and the predicted label. In some cases, the graph classifier generates a predicted label for the pseudo-sample. In some cases, the training component computes the loss function by comparing the label and the predicted label for the pseudo-sample.

A loss function refers to a function that impacts how a machine learning model is trained in a supervised learning model. For example, during each training iteration, the output of the machine learning model is compared to the known annotation information in the training data. The loss function provides a value (the “loss”) for how close the predicted annotation data is to the actual annotation data. After computing the loss, the parameters of the model are updated accordingly and a new set of predictions are made during the next iteration.

Supervised learning is one of three basic machine learning paradigms, alongside unsupervised learning and reinforcement learning. Supervised learning is a machine learning technique based on learning a function that maps an input to an output based on example input-output pairs. Supervised learning generates a function for predicting labeled data based on labeled training data consisting of a set of training examples. In some cases, each example is a pair consisting of an input object (typically a vector) and a desired output value (i.e., a single value, or an output vector). In some cases, a supervised learning algorithm analyzes the training data and produces the inferred function, which can be used for mapping new examples. In some cases, the learning results in a function that correctly determines the class labels for unseen instances. In other words, the learning algorithm generalizes from the training data to unseen examples.

Weak supervision in machine learning refers to training a machine learning model using partially labeled or noisy training data, as opposed to traditional supervised learning where each training example is precisely labeled. In some cases, by determining the loss function based on the label and a predicted label for the pseudo-sample, the system is able to employ weak supervision to train a graph classifier that is able to accurately identify an emergent misinformation style represented in the pseudo-sample.

According to some aspects, the training component performs further training of the graph classifier as described with reference to FIG. 11.

FIG. 9 shows an example of a text graph 900 according to aspects of the present disclosure. Text graph 900 is an example of, or includes aspects of, the corresponding element described with reference to FIG. 3. In one aspect, text graph 900 includes root node 905, first edge 910, second node 915, second edge 920, third node 925, third edge 930, and fourth node 935.

In the example of FIG. 9, root node 905 is connected to second node 915 by first edge 910 and to third node 925 by second edge 920, and second node 915 is connected to fourth node 935 by third edge 930. Each of root node 905, second node 915, third node 925, and fourth node 935 are representations of text, such as a social media post, and each of first edge 910, second edge 920, and third edge 930 represent respective relationships among root node 905, second node 915, third node 925, and fourth node 935. For example, in some cases, first edge 910 indicates that second node 915 is a representation of a text response to text represented by root node 905.

FIG. 10 shows an example of a modified text graph 1000 according to aspects of the present disclosure. In one aspect, modified text graph 1000 includes root node 1005, first edge 1010, second node 1015, second edge 1020, and third node 1025. Referring to FIG. 10, modified text graph 1000 is a modification of the text graph described with reference to FIG. 9. Referring to FIGS. 9 and 10, modified text graph 1000 has been modified to remove a child node (e.g., a response) connected to a root node.

FIG. 11 shows an example of a method 1100 for training a graph classifier based on a predicted pseudo-sample according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 11, according to some aspects, the training component performs further training of a graph classifier (such as the graph classifier described with reference to FIG. 2) using an unlabeled sample. In some cases, the graph classifier and the training component execute self-training of the graph classifier following the training process described with reference to FIG. 9 using the unlabeled sample. In some cases, by using the unlabeled sample, the training component is able to further increase or augment a training data set for the graph classifier, allowing an accuracy of the graph classifier to be further increased.

At operation 1105, the system obtains an unlabeled sample including an additional text graph. In some cases, the operations of this step refer to, or may be performed by, a graph classifier as described with reference to FIGS. 2-5. In some cases, the graph classifier retrieves the unlabeled sample from a database (such as the database described with reference to FIG. 1). In some cases, a user (such as the user described with reference to FIGS. 1-2) provides the unlabeled sample to the graph classifier.

At operation 1110, the system generates a pseudo-label for the unlabeled sample using the graph classifier to obtain a predicted pseudo-sample including the unlabeled sample and the pseudo-label. In some cases, the operations of this step refer to, or may be performed by, a graph classifier as described with reference to FIGS. 2-5.

At operation 1115, the system performs additional training of the graph classifier based on the predicted pseudo-sample. In some cases, the operations of this step refer to, or may be performed by, a training component as described with reference to FIGS. 2, 4, and 5. For example, in some cases, the additional training is performed by executing self-training based on the unlabeled sample based on the predicted pseudo-sample.

Self-training is a semi-supervised machine learning technique in which a machine learning model is initially trained on a set of labeled data. Subsequently, the machine learning model makes predictions on unlabeled data, and instances with high-confidence predictions are added to the labeled dataset. The machine learning model is then retrained on this expanded dataset, and the process is iteratively repeated for multiple rounds.

In some cases, the training component applies a confidence threshold to the predicted pseudo-sample. In some cases, the training component adds the predicted pseudo-sample to the training data set when a confidence prediction for the predicted pseudo-sample exceeds the confidence threshold. In some cases, the training component retrains the graph classifier using the predicted pseudo-sample as a training sample as described with reference to FIG. 8.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for identifying misinformation, comprising:
obtaining a training sample comprising a text graph and a label indicating whether the text graph includes misinformation;
generating a pseudo-sample by modifying the text graph to obtain a modified text graph, wherein the pseudo-sample includes the modified text graph and the label; and
training a graph classifier to identify misinformation using the training sample and the pseudo-sample.

2. The method of claim 1, wherein:
the text graph includes a root node and the label indicates whether the root node includes misinformation.

3. The method of claim 1, further comprising:
obtaining an unlabeled sample including an additional text graph;
generating a pseudo-label for the unlabeled sample using the graph classifier to obtain a predicted pseudo-sample including the unlabeled sample and the pseudo-label; and
performing additional training of the graph classifier based on the predicted pseudo-sample.

4. The method of claim 1, wherein:
the text graph includes a plurality of text nodes and at least one edge connecting at least two of the plurality of text nodes.

5. The method of claim 4, wherein modifying the text graph comprises:
adding an additional text node or an additional edge.

6. The method of claim 4, wherein modifying the text graph comprises:
removing at least one of the plurality of text nodes or the at least one edge.

7. The method of claim 4, wherein modifying the text graph comprises:
modifying at least one of the plurality of text nodes.

8. The method of claim 4, further comprising:
computing a node embedding for each of the plurality of text nodes, wherein the graph classifier takes the node embedding as input.

9. The method of claim 1, wherein training the graph classifier comprises:
generating a predicted label for the text graph; and
computing a loss function based on the label and the predicted label.

10. A method for identifying misinformation, comprising:
obtaining a text graph;
generating a label for the text graph using a graph classifier, wherein the graph classifier is trained to identify misinformation based on a pseudo-sample obtained by modifying a graph structure of a training sample; and
identifying misinformation in the text graph based on the label.

11. The method of claim 10, wherein:
the text graph includes a plurality of text nodes and at least one edge connecting at least two of the plurality of text nodes.

12. The method of claim 10, wherein:
the text graph comprises a social media post.

13. The method of claim 12, further comprising:
performing a moderation action based on identifying misinformation in the text graph.

14. The method of claim 12, wherein:
the text graph includes a response to the social media post.

15. An apparatus for identifying misinformation, comprising:
at least one memory component;
at least one processor configured to execute instructions stored in the at least one memory component; and
a graph classifier comprising parameters stored in the at least one memory component, the graph classifier trained to identify misinformation based on a pseudo-sample obtained by modifying a graph structure of a training sample.

16. The apparatus of claim 15, further comprising:
a training component configured to train the graph classifier.

17. The apparatus of claim 15, further comprising:
a pseudo-sample generator configured to generate the pseudo-sample.

18. The apparatus of claim 17, wherein:
the pseudo-sample generator comprises a language generation model.

19. The apparatus of claim 15, further comprising:
a text encoder configured to compute a node embedding for the training sample.

20. The apparatus of claim 15, further comprising:
a social media application configured to perform a moderation action based on identifying misinformation.
